(19) United States
(12) Patent Application Publication
(10) Pub. No.: US 2025/0202312 A1
(43) Pub. Date: Jun. 19, 2025

(54) SLIM DISK DRIVE DEVICE FOR FRICTION GENERATOR

(71) Applicant: AMOTECH CO., LTD, Incheon (KR)

(72) Inventor: Jeong Hoon LEE, Incheon (KR)

(21) Appl. No.: 19/066,475

(22) Filed: Feb. 28, 2025

Related U.S. Application Data
(63) Continuation-in-part of application No. PCT/KR2023/012503, filed on Aug. 23, 2023.

(30) Foreign Application Priority Data
Aug. 29, 2022 (KR) 10-2022-0108241

(51) Int. Cl. H02K 5/10; H02K 1/278; H02K 3/34; H02K 5/16; H02K 7/00; H02K 11/215

(52) U.S. Cl. CPC H02K 5/10; H02K 1/278; H02K 3/345; H02K 5/163; H02K 7/003; H02K 11/215; H02K 2211/03

(57) ABSTRACT

Provided is a slim disk drive device for a friction generator to rotate a disk used in the friction generator. The disk drive device for a friction generator includes: a motor housing including an annular trench-type concave groove on a lower side thereof; a motor cover coupled to a lower portion of the motor housing to configure the inside of the trench-type concave groove to a sealing state; a stator arranged in the sealed trench-type concave groove to generate a rotating magnetic field to rotate a rotor; and the rotor rotatably arranged to have an air gap inside the stator and having a sealing structure by a rotor support body except for the exposed surface facing the stator, wherein a ferrite magnet is arranged on the exposed surface of the rotor.

### TECHNICAL FIELD

The present invention relates to a slim disk drive device, and more particularly, to a slim disk drive device for a friction (or triboelectric) generator for rotating a disk used in the friction generator.

### BACKGROUND ART

The conventional energy harvesting technology mainly provides self-power to a system requiring low power. In addition, the existing energy harvesting technology has mainly used an electromagnetic system, a piezoelectric system, a thermoelectric system, a solar power generation system, and the like.

However, most devices using the existing energy harvesting technology have a large volume and low power density, and incur inefficient energy harvesting in a low frequency band such as a movement of a human body in energy harvesting. In order to solve this problem, a friction generator using frictional electricity, which is one of energy harvesting methods, has been developed.

The friction generator generates energy through a contact electrification phenomenon using specific materials having electrical polarities after frictional contact between two different materials.

However, the friction generator developed so far produces energy by contacting two solids having different electrical characteristics. Friction generators that generate power by contacting two solids with each other cause wear and tear due to friction, and thus, there is a disadvantage in that the longer the time and number of operations, the shorter the lifespan. In addition, the friction generator is greatly affected by the roughness between the two surfaces, and has the disadvantage of low energy harvesting efficiency.

In order to solve the disadvantages of the solid-solid friction generator, a fluid-solid friction generator with almost no friction due to relative motion has been developed. The fluid-solid friction generator is a method of generating electricity using a frictional electricity generated between water droplets and a non-conductive film, and an electrostatic induction phenomenon generated by moving charges charged in the water droplets, and a theoretical basis thereof is relatively simple and clear.

However, since the water droplet has a very small size, the contact area with the non-conductive film is small. When the contact area with the non-conductive film becomes smaller, less frictional electricity is generated, and accordingly, an electrostatic induction phenomenon is also low. Therefore, since the conventional fluid-solid friction generator has a very small output, the conventional fluid-solid friction generator is not appropriate for a device for energy harvesting.

In consideration of the problems of a conventional fluid-solid friction generator, Korean Patent Laid-Open Publication No. 10-2022-0043724 (Patent Document 1) discloses an abnormal flow fluid friction generator using an electronegativity difference, which includes: a tube which is a nonconductor and in which a fluid flows; a first cell formed of a material having a more positive (+) tendency than the tube and formed in a tube shape to replace a first portion of the tube to be coupled side by side to the tube; a second cell formed of a material having a more negative (−) tendency than the tube and formed in a tube shape to replace a second portion of the tube to be coupled side by side to the tube; a first electrode attached to the first cell; and a second electrode attached to the second cell.

### DISCLOSURE

### Technical Problem

Accordingly, it is an objective of the present invention to provide a slim disk drive device for a friction generator for rotating a disk used in the friction generator.

It is another objective of the present invention to provide a slim disk drive device for a friction generator having a sealing structure in consideration of an operation state in the fluid and the air.

It is another objective of the present invention to provide a slim disk drive device for a friction generator, which may rotate a disk having a high weight/large diameter as an output of low speed/high torque while having a slim structure.

### Technical Solution

According to an embodiment of the present invention, there is provided a disk drive device for a friction generator including: a motor housing having an annular trench-type concave groove at a lower side thereof; a motor cover coupled to a lower portion of the motor housing to configure the inside of the trench-type concave groove to a sealing state; a stator arranged in the sealed trench-type concave groove to generate a rotating magnetic field to rotate a rotor; and the rotor rotatably arranged to have an air gap inside the stator and having a sealing structure by a rotor support body except for the exposed surface facing the stator, wherein a ferrite magnet is arranged on the exposed surface of the rotor, wherein a ferrite magnet is arranged on the exposed surface of the rotor.

The disk drive device for a friction generator may further include: a bearing housing extending from an inner circumferential portion of the motor housing and formed to support a bearing at a central portion thereof; at least one bearing installed inside the bearing housing; and a hollow shaft accommodating portion extending from the rotor support to the central portion and rotatably supported by the bearing.

In addition, the disk drive device for a friction generator may further include a C-type rotor separation preventing ring coupled to a concave groove formed at a lower end of the shaft accommodating portion, to prevent the rotor from being separated.

In this case, the inner circumferential portion of the shaft accommodation portion may have a polygonal structure, and a rotation shaft coupled to the shaft accommodation portion may have a polygonal shape.

The disk drive device for a friction generator may further include a plurality of reinforcing ribs installed between the outer circumferential surface of the bearing housing and an extension portion to stably support the bearing housing from the extension portion.

The bearing may be a waterproof ball bearing or a plastic bearing.

The rotary shaft coupled to the shaft accommodating portion may include brass that is electrically conducted, and a rotary disk coupled to a front end portion of the rotary shaft may include aluminum.

In addition, the rotary disk may be rotatably supported by a cylindrical roller installed at an upper portion of a base having a lower side which is elastically supported by a spring.

The disk drive device for a friction generator may further include: a sealing first O-ring inserted into an annular first concave groove formed in an outer circumferential portion of the motor housing; and a sealing second O-ring inserted into a second concave groove formed in an extension portion connecting the outer circumferential part of the motor housing with the bearing housing.

In this case, the disk drive device for a friction generator may further include: a first fixing bolt fastened to a through-hole formed in each of a plurality of protrusions of the motor cover and the motor housing so as to maintain a sealing state from the outside by the sealing first O-ring; and a fixing screw fastened between the motor cover and the motor housing so as to maintain a sealing state from the inside by the sealing second O-ring.

The stator may include: a stator core including a plurality of teeth each having a T-shaped front end portion extending in an axial direction and a back yoke interconnected to the plurality of teeth to form a magnetic circuit; upper and lower insulators surrounding a coil winding region of each of the plurality of teeth by half in upper and lower portions thereof; and a coil wound around an outer circumferential surface of each of the upper and lower insulators, wherein each of the upper and lower insulators may include: an annular base frame having a predetermined width; and a plurality of teeth accommodating portions protruding from the base frame and receiving the winding areas of the teeth from the upper portion and the lower portion by half.

In this case, the disk drive device for a friction generator may further include a printed circuit board (PCB) which is adjacent to the stator, includes a Hall sensor mounted close to a portion where a magnet of the rotor is located, and end lines of the U, V, and W three-phase coils of the stator which are commonly connected to form a Y-connection neutral point (COM).

### Advantageous Effects

As described above, the present invention may provide a slim disk drive device for a friction generator for rotating a disk used in the friction generator.

Further, in the present invention, the rotor and the stator have a sealing structure in consideration of an operation state of the fluid and the air.

Furthermore, in the present invention, a disk having a slim structure and a high weight/large diameter may be rotationally driven with an output of low speed/high torque.

### BRIEF DESCRIPTION OF THE DRAWINGS

FIGS. 1A and 1B are perspective views of a slim disk drive device for a friction generator according to an embodiment of the present invention, when viewed from the top and the bottom thereof, respectively.

FIGS. 2A and 2B are a plan view and a bottom view of a slim disk drive device for a friction generator according to an embodiment of the present invention, respectively.

FIGS. 3A and 3B are cross-sectional views of lines A-A and B-B of FIG. 2A, respectively.

FIGS. 4A and 4B are modular exploded perspective view of a slim disk drive device for a friction generator according to an embodiment of the present invention, when viewed from the top and the bottom thereof, respectively.

FIG. 5 is an exploded perspective view illustrating a slim disk drive device for a friction generator according to the present invention.

FIG. 6 is a schematic configuration diagram illustrating a slim disk drive device for a friction generator according to an embodiment of the present invention, which is applied to a friction generator.

### DETAILED DESCRIPTION OF THE INVENTION

Hereinafter, embodiments of the present invention will be described in detail with reference to the accompanying drawings.

The sizes and shapes of the components shown in the drawings may be exaggerated for clarity and convenience. In addition, terms defined in consideration of the configuration and operation of the present invention may vary depending on the intention or custom of the user, the operator, and the like. Definitions of these terms should be based on the content of this specification.

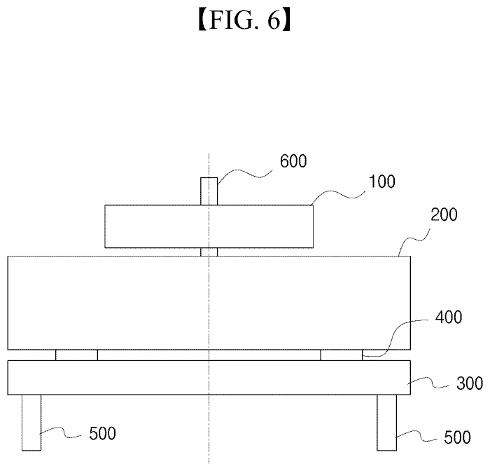

First, referring to FIG. 6, a slim disk drive device for a friction (or triboelectric) generator according to the present invention rotates a rotary disk 200 made of a metal material arranged at a lower portion through a rotary shaft 600, by using a rotating drive power of a drive motor 100.

The rotary disk 200 is rotatably installed on a cylindrical roller 400 installed on an upper portion of a base 300 having a lower side elastically supported by a spring 500.

The entire power generation system including the rotary disk 200 and the driving motor 100 is configured to rotate the rotary disk 200 while repeating the ascending and descending operations to have a state in the fluid of the alkaline solution and a state in the air.

In this case, the disk drive device has a pancake type appearance in which the drive motor 100 has a diameter of 200 mm and a thickness of 25 mm, and the disk drive device rotates the rotary disk 200 made of a weight of about 8 kg, a diameter of 300 mm, and aluminum (Al) at a low speed of about 100 rpm, to thereby generate power in a frictional manner.

The electricity generated by the frictional manner may be drawn out through the rotary shaft 600, which is made of brass which is a conductor, and a slip ring may be added to an electricity drawn-out portion.

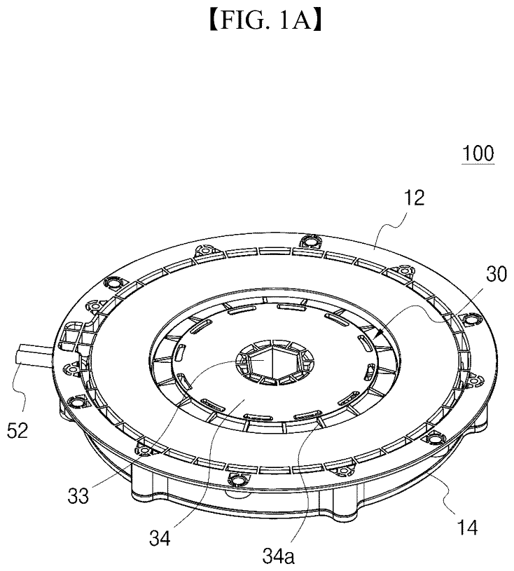

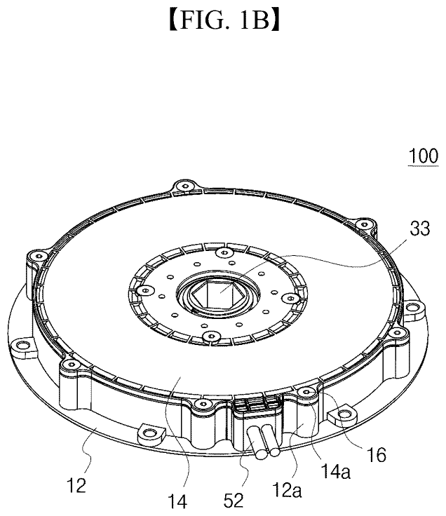

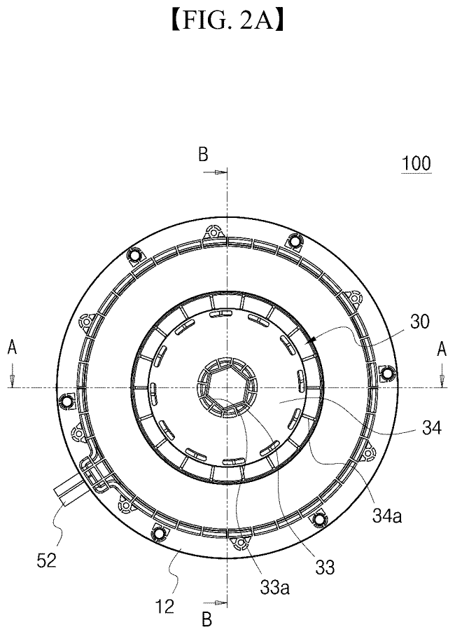

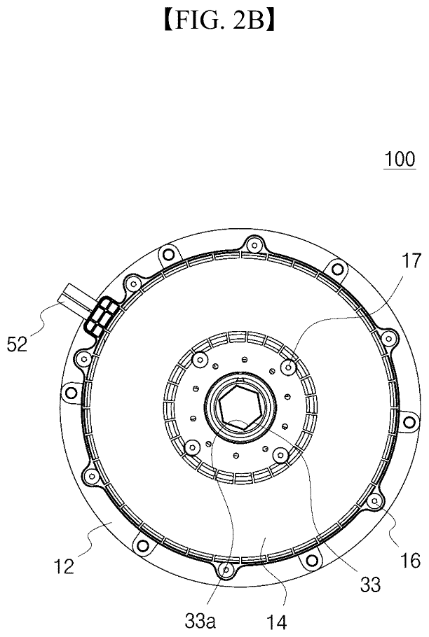

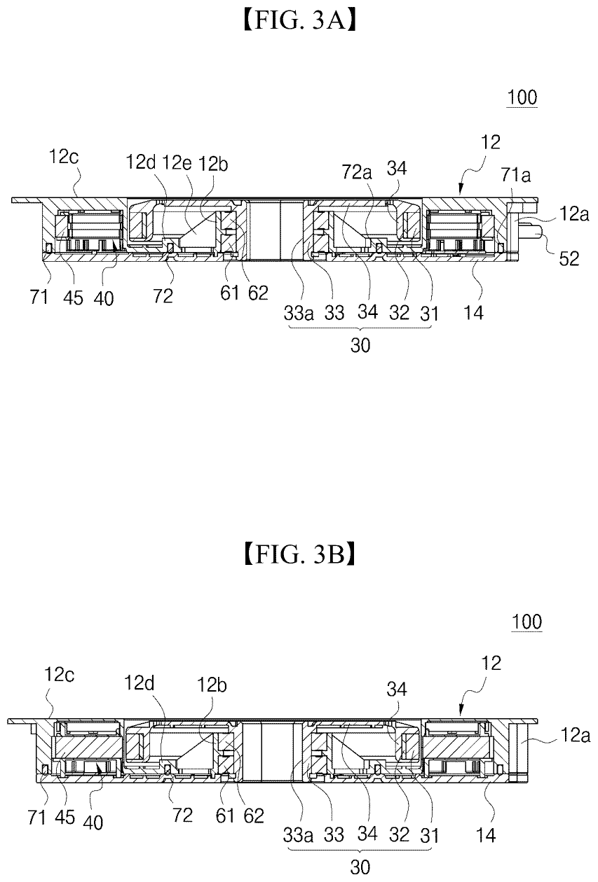

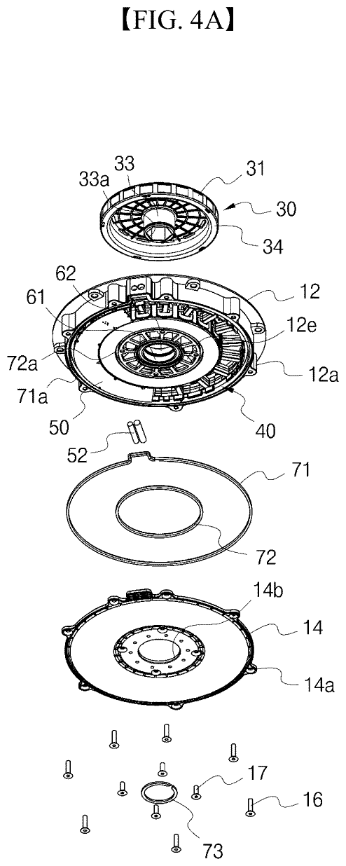

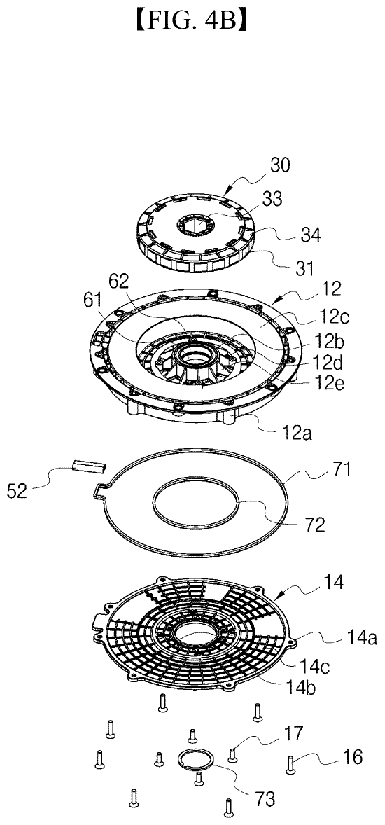

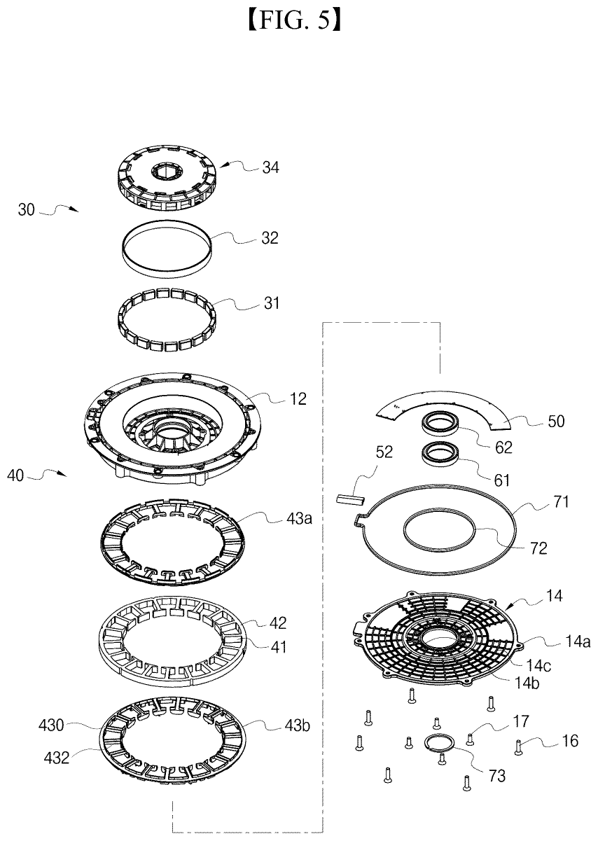

As shown in FIGS. 1A to 5, the drive motor 100 according to the present invention may be configured as an inner rotor type in which a rotor 30 is arranged inside a stator 40, and the stator 40 and the rotor 30 each have a sealing structure so as to have a structure in which the stator 40 and the rotor 30 may rotate in a liquid state.

To this end, in the rotor 30, the remaining portion of a magnet 31 except for the exposed surface portion facing the stator 40 and a back yoke 32 installed at the inner circumferential portion of the magnet 31 are insert-molded into a rotor support 34.

The magnet 31 may employ a magnet in which an N-pole and an S-pole are split into a multi-pole in a ring-shaped magnet or split magnet segments of a plurality of N-poles and S-poles, and the back yoke 32 is installed on the rear surface of the magnet 31 to form a magnetic circuit.

In this case, the magnet 31 may use a ferrite magnet, which is a magnetic material that does not melt in the water, and the rotor support 34 may use a polyphenylene sulphide (PPS) resin suitable in the water. In this case, the rotor support 34 may preferably use PPS+GF40% in which the glass fibers (GF) are reinforced.

The rotor 30 may include a shaft accommodating portion 33 having a polygonal structure such that the rotor support 34 accommodates the rotary shaft 600 in the central portion thereof and reinforces the coupling force. A polygonal through-hole 33a of the shaft accommodating portion 33 may be formed in a hexagonal shape, for example.

The stator 40 arranged outside the rotor 30 is arranged inside a sealing structure formed by a motor housing 12 and a motor cover 14.

First, the stator 40 includes: a stator core 45 having a plurality of teeth 41 each having a “T” shape and an annular back yoke 42 interconnected with the plurality of teeth 41 to form a magnetic circuit; upper and lower insulators 43a and 43b made of an insulating material and coupled to an upper portion and a lower portion of each of the plurality of teeth 41, except for an exposed surface of each of the plurality of teeth 41 facing the magnet 31, so as to surround, by half, the outer circumferential surface to which a coil 44 is wound; and the coil 44 wound around the outer circumferential surfaces of the upper and lower insulators 43a and 43b.

Each of the upper and lower insulators 43a and 43b includes: an annular base frame 430 having a predetermined width; and a plurality of teeth accommodating portions 432 protruding from the base frame and receiving the winding areas of the teeth from the upper portion and the lower portion by half.

In addition, the upper and lower insulators 43a and 43b may include a bobbin made of an insulating material integrally formed to surround an outer circumferential surface around which the coil 44 of each of the plurality of teeth 41 is wound.

The upper and lower insulators 43a and 43b may be a polyamid (PA) 66 resin with excellent insulating performance. In this case, the upper and lower insulators 43a and 43b may preferably use PA66+GF30% reinforced with glass fibers.

The body 12c of the motor housing 12 forms an annular trench-type concave groove to accommodate the annular stator 40 in the lower portion thereof, and the inner circumference of the body 12c is bent vertically after an extension portion 12d extends to the center thereof, to form a bearing housing 12b facing the polygonal shaft accommodating portion 33 of the rotor 30.

A pair of bearings 61 and 62 are inserted between the polygonal shaft accommodating portion 33 of the rotor 30 and the bearing housing 12b to rotatably support the polygonal shaft accommodating portion 33 of the rotor 30.

A concave groove is formed at the lower end portion of the polygonal shaft accommodating portion 33 to couple a C-shaped rotor separation prevention ring 73 therewith to prevent separation of the rotor 30.

The pair of bearings 61 and 62 may adopt a waterproof ball bearing or a plastic bearing. In the case of a waterproof ball bearing, the inner race of the waterproof ball bearing may be supported on the outer circumference of the polygonal shaft accommodating portion 33 and the outer race thereof may be installed to be supported on the inner circumference of the bearing housing 12b.

A plurality of reinforcing ribs 12e are formed between the outer circumferential surface of the bearing housing 12b and the extension portion 12d to stably support the bearing housing 12b from the extension portion 12d. Furthermore, the extension portion 12d may have a plurality of reinforcing ribs made of annular and radial directions in consideration of the thin film thickness, and the body 12c and the bearing housing 12b may be connected in the form of multiple bridges by providing weight loss space as needed.

An annular concave groove 71a into which a portion of a sealing O-ring 71 is inserted is formed under the body 12c bonded to the outer periphery of the motor cover 14, and an annular concave groove 72a into which a portion of a sealing O-ring 72 is inserted is also formed in the extension portion 12d.

In this case, the sealing O-rings 71 and 72 may use angular rings having a prismatic shape instead of an O-shaped cross-section.

The motor cover 14 coupled to the motor housing 12 has a through hole 14b formed at the center thereof, and the plurality of reinforcing ribs 14c formed in an annular and radial direction protrude from the upper surface thereof in consideration of a thin film thickness.

In the motor housing 12 and the motor cover 14, a plurality of protrusions 12a and 14a with respective through holes are protruded opposite to each other to fasten and fix fixing bolts or screws 16 and 17 on the outer periphery to maintain a sealing state from the outside by the sealing O-ring 71.

Additionally, the fixing bolts or screws 16 and 17 may be fastened to the inside of the motor cover 14 to maintain a sealing state from the inside by the sealing O-ring 72.

The motor housing 12 and the motor cover 14 may be made of a polyphenylene sulfide (PPS) resin suitable for water. In addition, the motor housing 12 and the motor cover 14 may preferably use PPS+GF40% in which the glass fibers (GF) are reinforced.

In the drive motor 100 according to the present invention, the stator 40 is assembled in the trench-type concave groove of the motor housing 12, the motor cover 14 is assembled in the state of inserting the sealing O-rings 71 and 72 in the annular concave grooves 71a and 72a, and then the fixing bolts or screws 16 and 17 are fastened.

Subsequently, the polygonal shaft accommodating portion 33 of the rotor 30 with a sealing structure and a pair of bearings 61 and 62 are assembled to the bearing housing 12b, and a C-type rotor separation prevention ring 73 is coupled therewith.

Thereafter, the assembly is completed by combining the rotary shaft 600 having a polygonal outer circumference with the through hole 33a of the polygonal shaft accommodating portion 33 of the rotor 30.

The drive motor 100 of the present invention is a radial gap type motor, and the plurality of teeth 41 of the stator core 45 and the magnet 31 of the rotor 30 face each other through an air gap.

The disk drive device according to this invention may include a brushless direct-current (BLDC) motor with a 20 pole-18 slot structure, for example, as the drive motor 100.

In addition, when the coils 44 of the stator 40 in the drive motor 100 are wound on eighteen teeth 41 in a U, V, and W three-phase structure to construct a circuit, the three-phase coils U1 to U6, V1 to V6, and W1 to W6 wound on six teeth 41 for each phase of U, V, and W are connected in series, and end lines are connected in a Y-connection manner, to form a neutral point (COM).

In a printed circuit board (PCB) 50 arranged adjacent to the stator 40, a Hall sensor is mounted so that the positioning is made close to the portion where the magnet 31 of the rotor 30 is located, and a neutral point (COM) of a Y-connection method is formed by connecting the end lines of the three-phase coils U1-U6, V1-V6, and W1-W6 in common.

Adjacent to the PCB 50, a pair of cables 52 required for connection with the motor drive circuit arranged outside are arranged to be drawn out to the outside in the motor housing 12.

The first cable includes a three-line wire drawn from the U, V, and W three-phase start terminals of the stator coil 44, and the second cable includes a three-wire wire connected to three Hall sensors and a two-line wire drawn from positive (+) and negative (−) power terminals.

Silicone is applied to the through hole of the motor housing 12 through which the pair of cables 52 pass to form a waterproof sealing.

The drive motor 100 according to the present invention may be driven by a 6-step radio wave drive method using an inverter circuit in a motor drive circuit after receiving a rotor position signal from a Hall sensor installed on the PCB 50.

While the present invention has been particularly shown and described with reference to exemplary embodiments thereof, by way of illustration and example only, it is clearly understood that the present invention is not to be construed as limiting the present invention, and various changes and modifications may be made by those skilled in the art within the protective scope of the invention without departing off the spirit of the present invention.

### INDUSTRIAL APPLICABILITY

The disk drive device of the present invention may be used to rotate a disk used in a friction generator.

What is claimed is:

1. A disk drive device for a friction generator, the disk derive device comprising: a motor housing having an annular trench-type concave groove at a lower side thereof;
a motor cover coupled to a lower portion of the motor housing to configure the inside of the trench-type concave groove to a sealing state;
a stator arranged in the sealed trench-type concave groove to generate a rotating magnetic field to rotate a rotor;
and the rotor rotatably arranged to have an air gap inside the stator and having a sealing structure by a rotor support body except for the exposed surface facing the stator, wherein a ferrite magnet is arranged on the exposed surface of the rotor, wherein
a ferrite magnet is arranged on the exposed surface of the rotor.

2. The disk drive device of claim 1, further comprising:
a bearing housing extending from an inner circumferential portion of the motor housing and formed to support a bearing at a central portion thereof;
at least one bearing installed inside the bearing housing; and
and a hollow shaft accommodating portion extending from the rotor support to the central portion and rotatably supported by the bearing to accommodate the rotary shaft.

3. The disk drive device of claim 2, further comprising a C-type rotor separation preventing ring coupled to a concave groove formed at a lower end of the shaft accommodating portion, to prevent the rotor from being separated.

4. The disk drive device of claim 2, wherein the inner circumferential portion of the shaft accommodation portion has a polygonal structure, and a rotation shaft coupled to the shaft accommodation portion has a polygonal shape.

5. The disk drive device of claim 2, further comprising a plurality of reinforcing ribs installed between the outer circumferential surface of the bearing housing and an extension portion to stably support the bearing housing from the extension portion.

6. The disk drive device of claim 2, wherein the bearing comprises a waterproof ball bearing or a plastic bearing.

7. The disk drive device of claim 2, wherein the rotary shaft coupled to the shaft accommodating portion comprises brass that is electrically conducted, and a rotary disk coupled to a front end portion of the rotary shaft comprises aluminum.

8. The disk drive device of claim 7, wherein the rotary disk is rotatably supported by a cylindrical roller installed at an upper portion of a base having a lower side which is elastically supported by a spring.

9. The disk drive device of claim 2, further comprising:
a sealing first O-ring inserted into an annular first concave groove formed in an outer circumferential portion of the motor housing; and
a sealing second O-ring inserted into a second concave groove formed in an extension portion connecting the outer circumferential part of the motor housing with the bearing housing.

10. The disk drive device of claim 9, further comprising:
a first fixing bolt fastened to a through-hole formed in each of a plurality of protrusions of the motor cover and the motor housing so as to maintain a sealing state from the outside by the sealing first O-ring; and
a fixing screw fastened between the motor cover and the motor housing so as to maintain a sealing state from the inside by the sealing second O-ring.

11. The disk drive device of claim 1, wherein the stator comprises:
a stator core including a plurality of teeth each having a T-shaped front end portion extending in an axial direction and a back yoke interconnected to the plurality of teeth to form a magnetic circuit;
upper and lower insulators surrounding a coil winding region of each of the plurality of teeth by half in upper and lower portions thereof; and
a coil wound around an outer circumferential surface of each of the upper and lower insulators, wherein
each of the upper and lower insulators comprises:
an annular base frame having a predetermined width; and
a plurality of teeth accommodating portions protruding from the base frame and receiving the winding regions of the teeth from the upper portion and the lower portion by half.

12. The disk drive device of claim 11, wherein a printed circuit board (PCB) which is adjacent to the stator, includes a Hall sensor mounted close to a portion where a magnet of the rotor is located, and end lines of the U, V, and W three-phase coils of the stator which are commonly connected to form a Y-connection neutral point (COM).
